(19) United States
(12) Patent Application Publication
(10) Pub. No.: US 2021/0062854 A1
(43) Pub. Date: Mar. 4, 2021

(54) Grounding Countersunk Screw with Segment Cutting Edge

(71) Applicant: Dieter Ramsauer, Schwelm (DE)

(72) Inventor: Dieter Ramsauer, Schwelm (DE)

(21) Appl. No.: 16/644,242

(22) PCT Filed: Aug. 20, 2018
(86) PCT No.: PCT/EP2018/072405

§ 371 Date: Mar. 4, 2020

(30) Foreign Application Priority Data
Sep. 7, 2017 (DE) 20 2017 004 671.7

(51) Int. Cl. F16B 35/06; H01R 4/64; H01R 4/30; H01R 4/34

(52) U.S. Cl. CPC F16B 35/065; H01R 4/34; H01R 4/304; H01R 4/64

(57) ABSTRACT

A ground connection with a grounding screw having a countersunk head with a countersinking region and having a cylindrical threaded shaft, proceeding from the countersunk head, for the mechanical and electrical connection of a first sheet-metal part to another metal part is described, wherein the first sheet-metal part resting on the head side of the grounding screw has a varnish layer on all sides, said varnish layer is broken through by a protrusion, proceeding from a countersinking region of the head, when the screw is tightened, wherein the head-side borehole is cylindrical and provided with a diameter D1 that is slightly smaller than the head diameter D2 of the head, and wherein the sheet edge of the first sheet-metal part uses, as counterbearing, the oblique circumferential surface of the grounding screw, which cuts through the varnish when the screw is tightened, without creating varnish chips. At the same time, the segment cutting edge or protrusion centres the grounding screw in the cylindrical borehole.

The invention relates to a ground connection with a grounding screw having a countersunk head with a countersinking region and having a cylindrical thread shaft proceeding from the countersunk head for the mechanical and electrical connection of a first metal part with another metal part, wherein the first sheet metal part resting on the head side of the grounding screw has a varnish layer on all sides, which is broken through by a projection proceeding from the countersinking region of the head when tightening the screw.

Such a ground connection is already known.

In addition, the invention also relates to a grounding screw with a countersunk head and cylindrical thread shaft proceeding from the countersunk head for the mechanical and electrical connection of a first metal part with another metal part, wherein the first sheet metal part resting on the head side has a varnish layer on all sides, which is broken through by a projection proceeding from a countersinking region of the head of the screw when tightening.

The above-mentioned two ground connections have different objects.

According to the first ground connection for a cylindrical borehole, the grounding takes place by means of a sharp sheet edge.

In the case of the second ground connection mentioned above, instead of a cylindrical borehole, a conical borehole or countersunk borehole is provided, in the case of which varnish penetration occurs with a segment cutting edge.

In the case of a third ground connection, a scraping tooth is in addition provided, which is secured by a projection and establishes a grounding contact, to achieve a secure grounding.

The object of the invention is to achieve the three objects using only one basically constructed grounding screw.

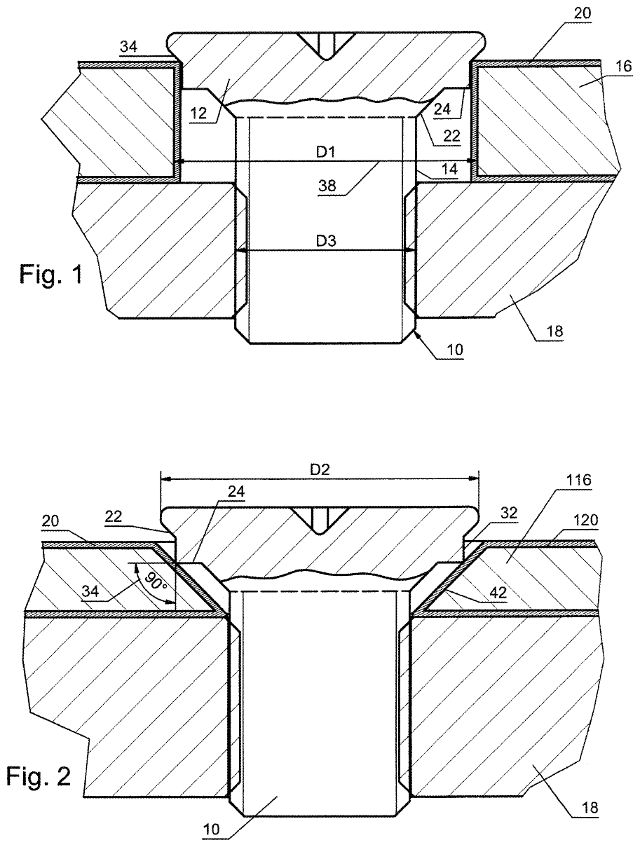

The first object is achieved in that the head-side borehole 36 is cylindrical and equipped with a diameter D1 which is slightly smaller than the head diameter D2 and in that the sheet edge of the first sheet metal part 16 uses, as a counter bearing, the oblique circumferential surface 34 of the grounding screw 10 which cuts through the varnish when tightening the screw without producing varnish chips, wherein at the same time the segment cutting edges or projection 24 centres the grounding screw in the cylindrical borehole 38 with diameter D1, see FIG. 1.

In the case of the second ground connection, the achievement of the object consists in that the head-side borehole is conical or sunk and in that the projection is formed by a segment cutting edge, see FIG. 2.

Finally, the object is achieved by the third embodiment in that the head-side borehole is cylindrical, wherein the projection is formed by a scraping tooth.

There are further developments of the invention, in this case the invention should not be limited to the partial case where the scraping tooth should necessarily be longer than the segment cutting edge. Since, when using the scraping tooth in a cylindrical borehole, the segment cutting edge perceives a centring function in the case of a corresponding diameter, it can be higher or even lower in this application than the height of the scraping tooth since the grounding function of the scraping tooth according to the invention is not influenced.

It should also be added that the segment cutting edge should be effective with sheets of different thicknesses and as a result the countersink of the borehole can certainly be different. In addition, it is not necessary to give too much consideration to the diameter.

According to another further development or alternative, the projection is realized by a segment cutting edge and by a tooth of half the height of the segment cutting edge height.

Moreover and according to a further development of the invention, the segment cutting edge has a slope to the cutting edge which is steep on both sides.

According to another embodiment, the segment cutting edge is provided with a slope to the cutting edge which is flat on both sides.

According to another embodiment of the invention, the segment cutting edge is provided with a slope to the cutting edge which is flat in the cutting direction and is, however, steep in the opposing direction.

The invention is described in greater detail below on the basis of exemplary embodiments which are represented in the figures, wherein:

FIG. 1 shows a grounding screw according to the invention in the working position in an axial sectional view with cylindrical borehole;

FIG. 2 shows an embodiment in the case of which the borehole is conical in the head-side sheet;

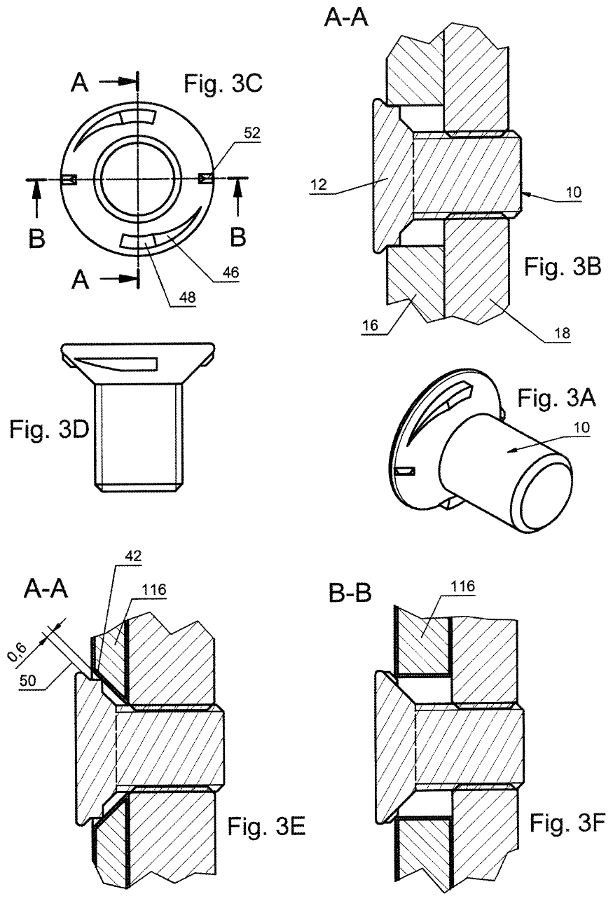

FIG. 3A shows a perspective representation of a first embodiment of a screw, which is provided for the invention;

FIG. 3B shows an axial sectional view through the screw along the cut line BB according to the representation of FIG. 3A,

FIG. 3C shows a view to the underside of the screw,

FIG. 3D shows a side view of the screw,

FIG. 3E shows the application of scraping teeth in the case of a conical borehole at the height of the head-side sheet;

FIG. 3F shows the application of the sharp edge as a scraping tooth;

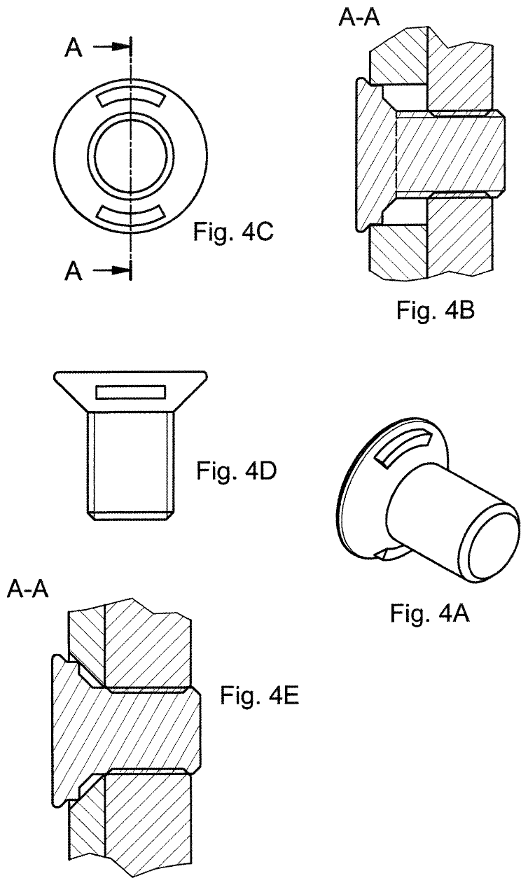

FIGS. 4A to 4E show corresponding representations for an alternative screw;

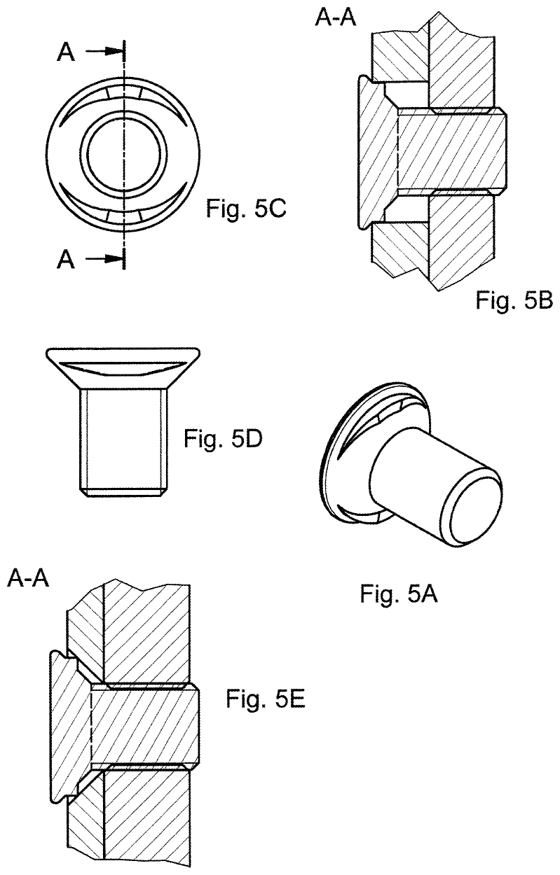

FIGS. 5A to 5E show another alternative screw in similar representations,

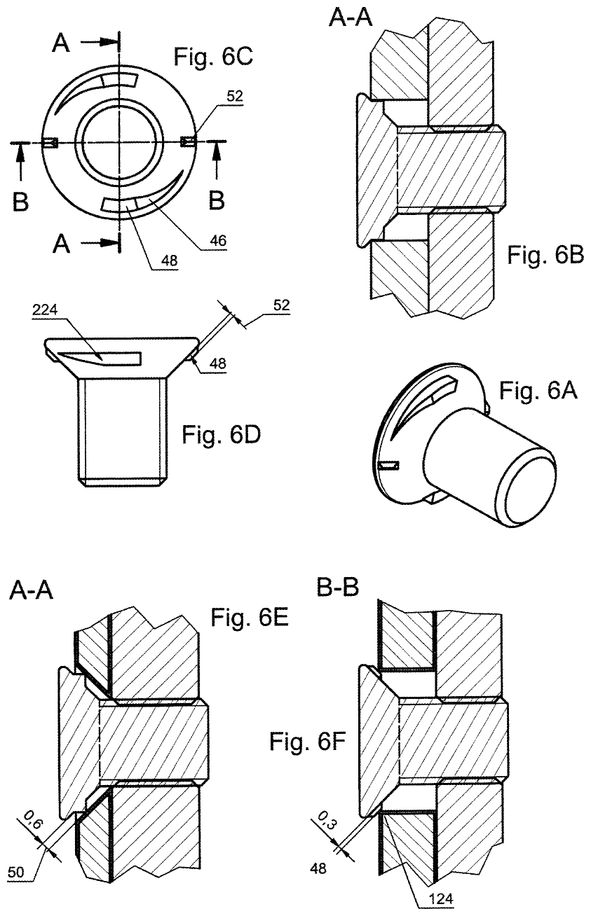

FIGS. 6A to 6E show another screw in similar representations, and

FIG. 6F shows the function of the screw in an alternative application.

FIG. 1 shows in an axial sectional view a grounding screw 10 with countersunk head 12, from which a cylindrical thread shaft 14 proceeds. The arrangement serves for the mechanical, electrical and centring connection of two sheet metal parts 16, 18, wherein at least the sheet part 16 resting on the head side has a varnish layer 20 on all sides. The grounding screw 10 should, according to FIG. 2, break through the varnish layer 20 with a projection 24 or scraping tooth proceeding from the countersinking region 22 when tightening the screw and establish a grounding contact between the screw 10 and the sheet 16, FIG. 2. A projection 24 can be discerned in the region of the countersink 22 which substantially has a centring function. The grounding function of the third alternative does not occur here.

In order to ensure the centring function, it is sufficient when the diameter D2 of the head 12 is slightly larger than the diameter D1 of the cylindrical borehole 38. Centring inside the opening of the cylindrical borehole 38 takes place through the segment cutting edge circumference. The centring segment cutting edge 32 is drawn into the edge region of the cylindrical borehole and in doing so is centred (also moved centrally to the borehole axis). The remaining inclination in the entire surface region of the grounding countersunk screw is sufficient to overcome any sideward displacements and to centre the screw in the middle.

This is in contrast to FIG. 2 where the same screw 10 is arranged, but in a conical borehole 42. The entire thickness of the sheet part 116 is available here as the inclination for centring.

Up to this point, countersunk boreholes were resunken after varnishing in order to remove the applied varnish once again in order to achieve a grounding with a normal countersunk screw. Such countersunk boreholes have certainly been previously covered with a rubber stopper in order to achieve such, namely varnish-free regions. FIG. 1 shows a sheet part 16 with a cylindrical borehole 38 and FIG. 2 a sheet part 116 with a countersunk borehole 42. With a cylindrical borehole which is set larger than the thread diameter D3 of the countersunk screw, a countersink can even be dispensed with to save costs. The countersunk screw will ensure only a small head protrusion for the size of the borehole, which is, however, acceptable. If the diameter D1 of the cylindrical borehole 38, on the one hand, is accordingly matched with the segment cutting edge—which is a decisive advantage—the segment cutting edge can develop a centring effect in the cylindrical borehole 38 itself. The varnished sheet with cylindrical borehole has a sharp 90° edge 34, the image in FIG. 1 shows such a cylindrical borehole. Even with such a cylindrical borehole 38, whose diameter D1 is set larger than the thread diameter D3 of the countersunk screw 12, a countersink can be dispensed with to save on costs. The varnished sheet 16 with cylindrical borehole 38 has a sharp 90° edge 34 which is opposite the grounding screw 10. If pressure is produced through the grounding screw 10 with the smooth part of the screw head 12 against the sharp edge 34 of the sheet 16, the sharp edge 34 of the sheet 16 will produce a similar effect as outlined above when used in a countersunk borehole 42. In FIG. 3E, the diameter of the segment cutting edge is designated with 50 and the diameter of the cylindrical borehole 38 with D1. If, by way of example of an M6 screw, the head diameter D2 of the screw is 11.5 mm and the diameter D1 of the cylindrical borehole 38 in the sheet is 8.8 mm, a sufficient separating effect does apply to the centring segment cutting edge in the case of a diameter of 8.5 mm.

In each case a screw with a different pattern of the cutting edge shape is provided in FIGS. 3A to 3E, 4A to 4E and 5A to 5E. All three screws are similar in their effect, but the longitudinal design and the slope to the cutting edge is different. In the case of the embodiment according to FIGS. 4A to 4E, the slope is steep on both sides. In the case of the embodiment according to FIGS. 5A to 5E, the slope is flat on both sides, while in the case of the embodiment according to FIGS. 3A to 3E, the slope is flat in the cutting direction, but steep in the opposite direction. The countersunk screws are conceived such that the screw used for varnished sheets with countersunk borehole is characterised by the reliability of the segment cutting edges. In the case of both applications, it is in each case the 90° corner with the sharp edge that penetrates the varnish 20, 120, see FIGS. 3F and 6F.

As FIG. 2 shows, the segment cutting edge in the case of a countersunk borehole 42 will only cut through the varnish layer with its 90° cross-section, displace the varnish and accordingly ensure grounding.

In the case of the embodiment according to FIGS. 6A to 6E, there is also a scraping tooth 48 in addition to the segment cutting edge 224. The guidance is therefore added during use of cylindrical boreholes. The grounding is thereby more secure. Chips may result during use with a cylindrical varnished borehole, but there are enough applications where this is not disruptive. In the case of using an M8 screw in conjunction with a countersunk borehole, the scraping tooth with a height of 0.3 mm would not be able to scrap, since the segment cutting edge has a height of around 0.6 mm. As a result, the scraping tooth 48 still has a sufficient distance from the varnish layer in the countersunk borehole 42, see FIG. 6E reference numeral 36.

In the case of the embodiment represented in FIGS. 6A to 6E, an application is added, in the case of which a scraping tooth 48 is added on the right for the application with cylindrical boreholes 38. The application is then more secure. Chips could result during use with a cylindrically varnished borehole 38, but there are enough applications where this is not disruptive. In the case of using this screw in conjunction with a countersunk borehole 42, the scraping tooth 48 with a height of 0.3 mm would not be able to scrap because the segment cutting edge 224 has a height of 0.6 mm. As a result, the scraping tooth still has a sufficient distance from the varnish layer 120 in the countersunk borehole 42.

Additional remarks on the figures:

FIG. 1: In the case of this sketch, the possible varnishing is represented. Views without scraping tooth. Segment cutting edge centred in the cylindrical borehole. Here no grounding function. 90° varnished sheet edge penetrates varnish layer. Counter bearing countersunk screw head.

FIG. 2: In the cross-section 90° segment cutting edge. Counter bearing is the countersunk borehole in order to penetrate the varnish. Conclusion: twice 90° corner, which helps to penetrate the varnish with the aid of a counter bearing. Varnish particle generation.

FIGS. 3A-3F: Segment cutting edge has no grounding function, but centres in the cylindrical borehole. The 90° offset scraping tooth takes over the grounding. Scraping tooth ensures, on the edge of the sheet, secure grounding whether or not varnished. In the case of using the grounding screw in a countersunk borehole, the segment cutting edge grounds, the scraping tooth has no function.

FIGS. 6A-6F: Grounding screw with segment cutting edge and scraping tooth. FIG. 6E: Since the segment cutting edge is 0.6 mm high, the 0.3 mm high scraping tooth cannot produce any varnish chips in the case of using the countersunk borehole. FIG. 6F: Scraping tooth for application with cylindrical borehole in order to make grounding more secure even though varnish chips could result (for application when this is not disruptive).

### LIST OF REFERENCE NUMERALS

10 grounding screw
12 countersunk head
14 cylindrical thread shaft, thread diameter D3
16, 116 head-side sheet part
18 additional metal part
20, 120 varnish layer
22 countersinking region of the countersunk head 12
24 projection (implemented differently) as:
124 sheet edge of the metal part 16
224 segment cutting edge
28 head, head diameter D2
32 outer surface of the segment cutting edge
34 90-degree edge, counter bearing and oblique circumferential surface of the countersinking region
36 countersunk surface
38 cylindrical borehole, diameter D1 of the cylindrical borehole 38
40 steep cutting edge
42 countersunk borehole, conical borehole
46 flat cutting edge
48 scraping tooth, additionally
50 height of the cutting edge
52 height of the scraping tooth

1. A ground connection with a grounding screw with countersunk head with countersinking region and with a cylindrical thread shaft proceeding from the countersunk head for the mechanical and electrical connection of a first sheet metal part with another metal part, wherein the first sheet metal part resting on the head side of the grounding screw has a varnish layer on all sides which is broken through by a projection proceeding from a countersinking region of the head when tightening the screw, characterised in that the head-side borehole is cylindrical and equipped with a diameter D1, which is slightly smaller than the head diameter D2 of the head and in that the sheet edge of the first sheet metal part uses, as a counter bearing, the oblique circumferential surface of the grounding screw which cuts through the varnish when tightening the screw without producing varnish chips; the segment cutting edge or the projection at the same time centres the grounding screw in the cylindrical borehole.

2. A ground connection with a grounding screw with countersunk head and in a countersinking region and with a cylindrical thread shaft proceeding from the countersunk head for the mechanical and electrical connection of a first sheet metal part and with another metal part, wherein the first sheet metal part resting on the head side has a varnish layer on all sides which is broken through by a projection proceeding from the countersinking region of the head when tightening the screw, characterised in that the head-side borehole is conical, and in that the projection is formed by a segment cutting edge.

3. A grounding screw with countersunk head and cylindrical thread shaft proceeding from the countersunk head for the mechanical and electrical connection of a first sheet metal part with another metal part, wherein the first sheet metal part resting on the head side has a varnish layer on all sides which is broken through by a projection proceeding from the countersinking region of the head of the screw when tightening the screw, characterised in that the head-side borehole is cylindrical, wherein the projection is formed by a scraping tooth.

4. The grounding screw with countersunk head according to claim 1, characterised in that the segment cutting edge has a slope to the cutting edge, which is steep on both sides.

5. The grounding screw according to claim 1, characterised in that the segment cutting edge has a slope to the cutting edge which is flat on both sides.

6. The grounding screw according to claim 1, characterised in that the segment cutting edge has a slope to the cutting edge which is flat in the cutting direction, steep in the opposing direction.

7. The grounding screw according to claim 1, characterised in that the segment cutting edge has a maximum height of 0.6 mm in the case of a grounding nut M6.

8. The grounding screw according to claim 7, characterised in that the scraping teeth are fixed between in each case two segment cutting edges.

9. The grounding screw according to claim 1, characterised in that the segment cutting edges are arranged offset to one another by 90°.
